(19) United States
(12) Patent Application Publication
(10) Pub. No.: US 2018/0211285 A1
(43) Pub. Date: Jul. 26, 2018

(54) SYSTEM AND METHOD FOR LEARNING FROM ENGAGEMENT LEVELS FOR PRESENTING TAILORED INFORMATION

(71) Applicant: PAYPAL, INC., San Jose, CA (US)

(72) Inventors: Michael Charles Todasco, Santa Clara, CA (US); Cheng Tian, San Jose, CA (US); Srivathsan Narasimhan, Saratoga, CA (US); Jiri Medlen, Fullerton, CA (US)

(21) Appl. No.: 15/411,942

(22) Filed: Jan. 20, 2017

(51) Int. Cl. G06Q 30/02

(52) U.S. Cl. CPC G06Q 30/0269; G06Q 30/0277; G06Q 30/0244

(57) ABSTRACT

Aspects of the present disclosure involve a system and method for presenting tailored information based on user engagement level. This engagement level which can be represented by a score in conjunction with a user profile can then be used to identify appropriate information to present to the user. The information presented can include advertisements, articles, and the like which have been learned/identified to trigger the user's interest.

### TECHNICAL FIELD

The present disclosure generally relates to communication devices for data presentation, and more specifically, to communication devices that present information based on an engagement level.

### BACKGROUND

Nowadays with the evolution and proliferation of devices, users are constantly connected to the internet, frequenting websites, searching for products, streaming videos, etc. In view of such evolution, the marketing and advertising industry has made it feasible to promote products and services while the user is connected. Generally, the promotion comes in the form of a digital advertisement that appears on the page that is currently being perused by the user. However, with the vast amount of information available on the device, advertisements or even articles that may be of interest to the user, may be inadequately presented and missed or ignored. Further, the user may be distracted and/or the advertisement presented may be irrelevant. Therefore, it would be beneficial to create a system that presents tailored information to a user while taking into account a user's interests and engagement level.

### BRIEF DESCRIPTION OF THE FIGURES

FIGS. 1A-1B illustrate graphical diagrams of user engagement.

FIGS. 2A-2D illustrate example various graphical user interfaces with information presentation on a display of a device that uses engagement levels.

FIG. 3 illustrates a flow diagram illustrating operations for learning and presenting information based on an engagement level.

FIG. 4 illustrates a block diagram of a system for presenting information based on the engagement level.

FIG. 5 illustrates an example block diagram of a computer system suitable for implementing one or more devices of the communication systems of FIGS. 1-4.

Embodiments of the present disclosure and their advantages are best understood by referring to the detailed description that follows. It should be appreciated that like reference numerals are used to identify like elements illustrated in one or more of the figures, whereas showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Aspects of the present disclosure involve systems, methods, devices, and the like for presenting tailored information, based on user engagement level. In one embodiment, a system is introduced that can learn from the user's engagement level. In particular, sensors on one or more device(s) can be used to measure how engaged (e.g. engagement level) a user is on the content presented on the device. This engagement level which can be represented by a score, which in conjunction with a user profile, can be used to identify appropriate information to present to the user. The information presented can include advertisements, articles, and the like which have been learned/identified to trigger the user's interest.

Conventionally, advertisements on user devices have come in the way of banners and/or other digital media on the screen that is currently being viewed by the user. The advertisements presented are randomly created and in some instances based on a user previous search of a product. However, these advertisements fail to take into account the user's direct interests and engagement level to determine if the user will consider the advertisement. For example, while a user may be an avid bicyclist, the user may not be in the mood for a bike ad, but rather be in the mood to listen a musical concerto. In this example, an ad for a local ‘musical show’ may be more relevant than an ad for a bike.

In one embodiment, a system is introduced that presents a user with tailored information based on the user's interest and engagement level. The user's interests may be retrieved from a user's profile, search history, purchase history, detected conversation, items worn, items owned, items purchased, etc. The user's engagement level may be determined using sensors on one or more devices being used by the user. The sensors can track eye movement, heart rate, and brain waves, record conversations, record environmental conditions, take images of the surroundings, measure stress levels, etc. The measured information can then be used to determine how engaged a user is on the current content on the device.

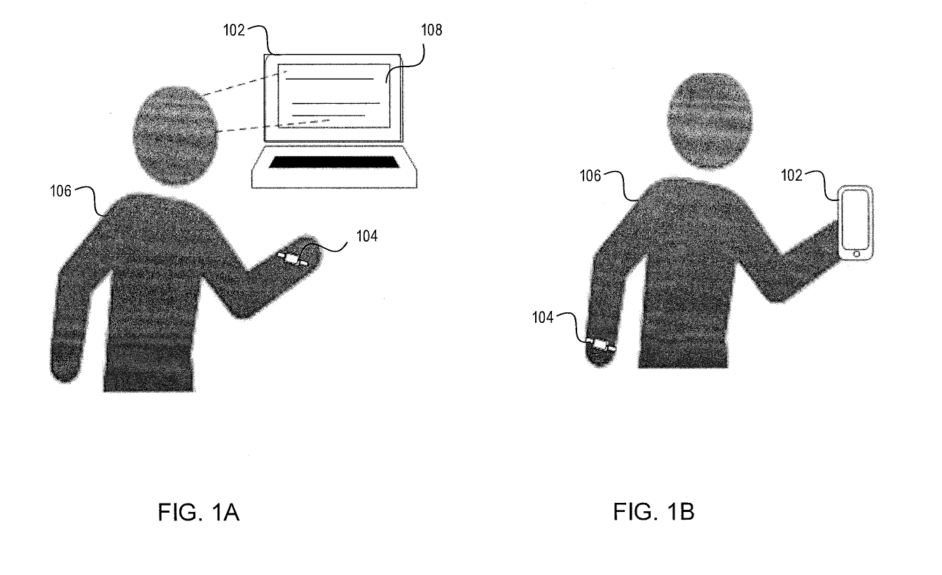

FIGS. 1A-1B illustrate graphical diagrams of user engagement. In particular, FIG. 1A illustrates user 106 involved with a device 102 (e.g., a laptop or computer) actively engaged in the content on the display 108. The device 102 which may be equipped with a camera (not shown) may be used to monitor the user's eye movement as a measure of the user's interest and engagement level on the content on the display 108. In addition, the user 106 may also be wearing a secondary device 104 which can monitor steps, heart rate, and other biometric information. The secondary device 104 can be any wearable device including but not limited to, a fitness tracker, smart watch, jewelry, smart goggles, etc. Thus, FIG. 1A may be an illustration of a user 106 sitting down in a relaxed state, reading an article of interest. The user's current state may be determined by the secondary device 104, while his engagement on the content may be a combination of both devices with camera sensors being used to determine eye movement.

In the alternative, as illustrated in FIG. 1B, the user 106 may exhibit a more passive state where the user's engagement level is relatively low with regards to the content on the device 102. For example, in FIG. 1B the user 106 may be walking en route to a location while viewing a video on the device 102 (e.g., smart phone). In this instance, as measure by the secondary user device 104 (e.g., smart watch) in conjunction with the device 102, the user 106 is exhibiting a low engagement level with regards to the content on display on device 102.

Note that FIGS. 1A and 1B are used for exemplifying a user 106 with a high engagement level and a user 106 with a low engagement level, however the embodiment is not so limited. For example, the user 106 may be sitting while frequenting multiple websites and/or numerous applications. In this case, the user is multitasking and thus exhibiting a low engagement level. As another example, the user 106 may be watching television or at a location with a high noise level, where engagement level may be low. Still as another example, the user may be interacting with multiple devices simultaneously. Consequently, shifting and/or switching between devices, while in no particular order, may signify a low engagement level. Thus, contextual ads may be presented using a mechanism which can sort/rank the engagement level by device 102, 104.

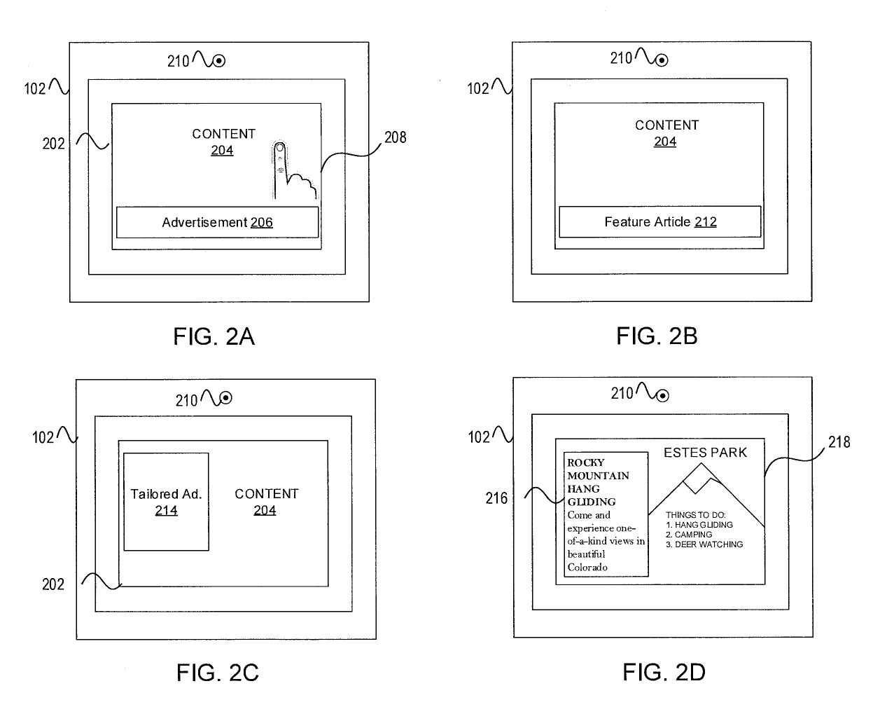

Once the user's engagement level is determined, then it is useful to identify what information (and where) to provide the user 106. FIGS. 2A-2D illustrate example of various graphical user interfaces with the information as identified, presented on the display 108 of the device 102. In particular, FIGS. 2A-2D illustrate how additional tailored information can be presented to a user 106 based on his/she engagement level. As indicated above, user engagement level can be a determination of how focused a user is on the current content/material or information on display on device 102. For example, if the user is surfing rapidly through various web sites, a user may have a low level of engagement on the current content on display on the device 102. The content may include but is not limited to, movies, videos, games, articles, music playing (with advertisements presented between songs), and the like.

FIG. 2A begins with a first example of a user interface with the main content 204 provided to a user on the majority of the display 202 of device 102. In addition to the main content 204, additional information can be presented to the user 106 in the form of advertisements 206. In some instances, the advertisements 206 may be minimal and presented on the lower portion of the display 202. However, in other instances the information may be adjacent to, above as a banner, a pop-up, or in any other portion of the display. In some embodiments, the advertisements or additional information presented to the user may be presented such that the information does not widely obstruct the content 204.

Turning back to FIG. 2A, the advertisement 206 is presented to user 106 on a lower portion of the display 202. As described above and in conjunction with FIG. 1, user biometrics may be measured in order to gage a user's engagement level. For example, a camera 210 may be used to measure eye movement and/or record user actions that can be used to determine how engaged a user is on the current content 204. Additionally, temperature sensors can exist on the screen display 202 which can sense how quickly a user is skimming through the content. For example, if the user has a touch display 202, the figure movement or input 208 on the screen can be measured. Additionally, other sensors including gyroscopes, accelerometers, heart rate monitors, light detectors, and the like may be present to measure user biometrics, and actions.

As the camera and other sensors (collectively referred to as sensors 110) are taking measurements, a user's profile may be retrieved to determine user interests in order to jointly tailor the information or advertisements 206 presented to the user. Algorithms such those implemented using machine learning, statistical analysis, probabilistic analysis, predictive analysis, etc. may be used to learn and determine what information to present.

Once the relevant information and a user's engagement level is determined, then the advertisement or other information may be displayed on the display 202 of device 102. In one embodiment, sensor measurements are collectively analyzed and used to determine an engagement level score that informs the system of how concentrated the user 106 is on the content 204. If the engagement score is low, then it can be said that a user 106 is not to engaged in the content 204 and thus a tailored information (e.g. advertisement 206), can be presented to a user 106 that has a greater possibility of being looked at, such that the engagement of the user is shifted to the information presented. The user 106, can then double click, hover, maximize, or in other form focus on the information presented.

Alternatively, if the engagement score is high, the user 106 may be to engaged on the current content 204 and thus pay minimal attention to what is on display at the lower portion of the display 202 (e.g., advertisement 206). Therefore, in some instance, where an engagement level is low, featured articles, advertisements, and other tailored information may be presented to a user. While in other instances, where the engagement level is high, more general advertisements (may still be tailored) may be presented. Additionally, a user's engagement level may continue to be monitored such that tailored information may be presented while content 204 of interest is on display.

FIG. 2A illustrates a first example where an engagement level may be high, with minimal screen manipulation, and a general advertisement 206 is presented. FIG. 2B illustrates a second example, where a user 106 may have a lower engagement level such that a featured article 212 is presented to the user. Content 204 may be of interest to a user 106, however, system determination indicates that an article may be presented such that the user 106 attention may be captured through the presentation of a featured article 212. Again, the featured article 212 or other information presented to the user may be a function of prior searches, user interests, hobbies, preferences, user profile, body chemistry conditions, and the like.

FIG. 2C illustrates a third example of how information may be presented to a user 106. In FIG. 2C, information may be presented to a user in the form of a tailored advertisement 214 adjacent to content 204. In this example, the tailored advertisement is selected and displayed based on the user engagement level. The user may be exhibiting a low engagement level or low interest in the current content 204 that placing an advertisement for a product of interest may be optimal. Note that in conjunction to the information presented to the user, placement of content may also be determined and updated based on engagement level, environmental factors, body chemistry conditions, device type, etc. For example, a user with a small hand-held device 102 may benefit from a tailored advertisement 214 that sits to the left of the content 204 as compared to a small banner at the bottom of display 202 or an ad below the screen that appears as the user 106 starts to scroll down. As another example, a user on a laptop may be provided with a tailored advertisement 214 adjacent to the content 204 due to its relevancy to the user.

FIG. 2D illustrates a fourth example of tailored information presented to a user 106. In particular, FIG. 2D illustrates an example of a user reading an article 218 on Estes Park, Colo. The article is directed to visiting the location and things to do there. The device 102, taking into consideration the user's current interests, biometrics, previously tagged searches, and having identified an engagement score, determines that a tailored advertisement 216 can be adequately presented. In particular, the device 102 may determine that the user is also interested in hang gliding. Therefore, FIG. 2D presents a tailored advertisement 216 directed to hang gliding in the Rocky Mountains, near Estes Park.

Note that FIGS. 2A-2D are for exemplary purposes and other examples, tailored information, and placement of information may be contemplated.

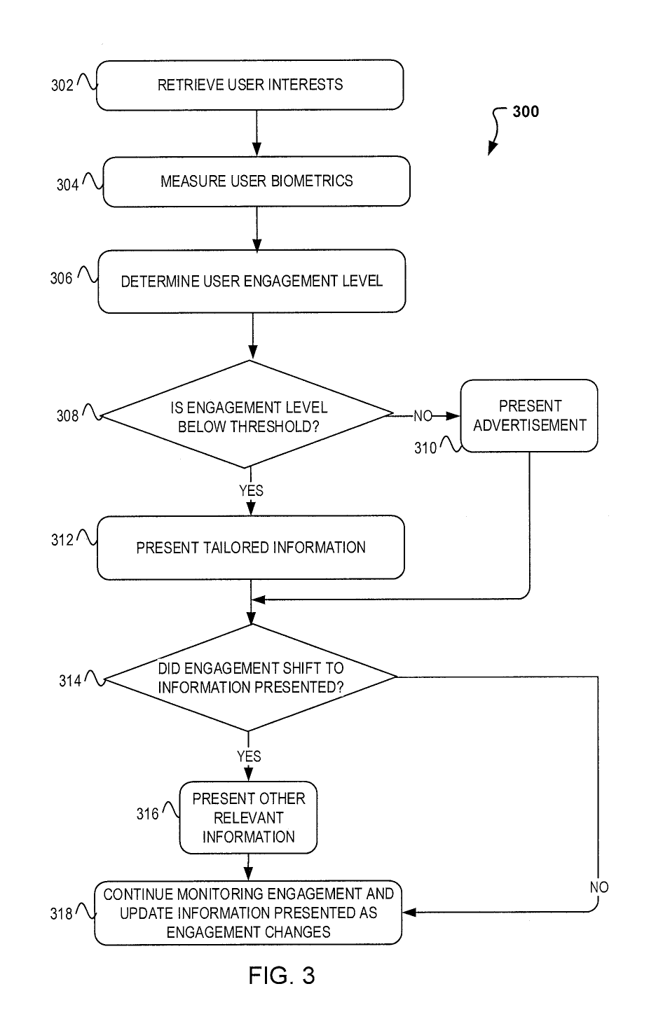

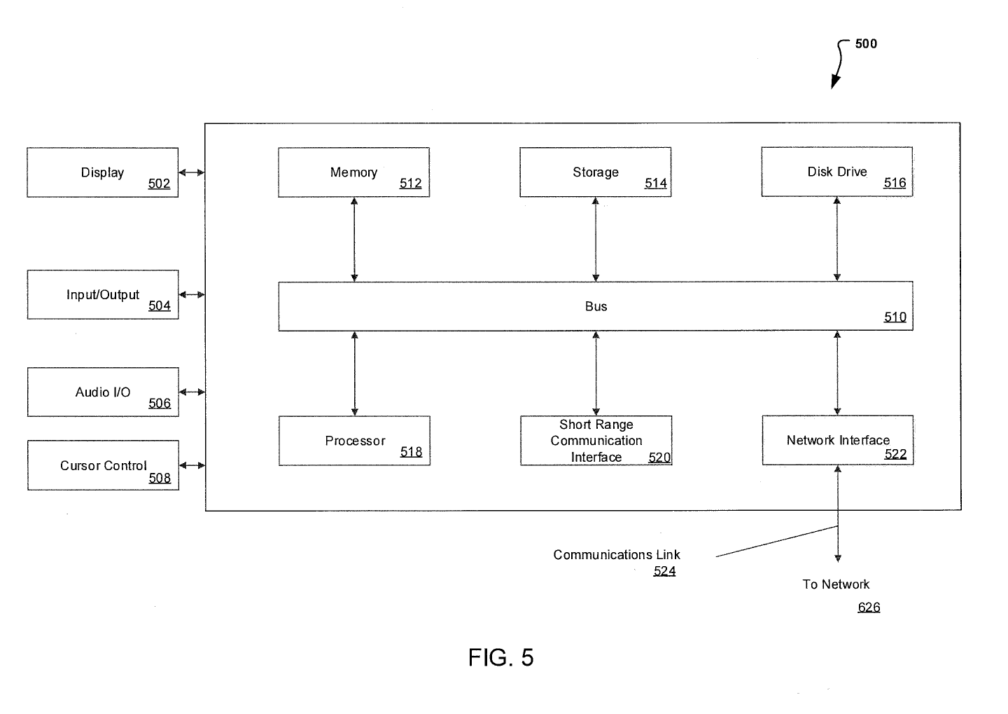

FIG. 3 illustrates example process 300 for learning from engagement levels for presenting tailored information that may be implemented on a system, such as system 500 and device 102 in FIGS. 1 and 5 respectively. In particular, FIG. 3 illustrates a flow diagram illustrating operations for presenting information to a user based on the engagement level of the user. According to some embodiments, process 300 may include one or more of operations 302-318, which may be implemented, at least in part, in the form of executable code stored on a non-transitory, tangible, machine readable media that, when run on one or more hardware processors, may cause a system to perform one or more of the operations 302-318.

Process 300 may begin with operation 302, where user profile are retrieved. Retrieving the user profile can be in response to inputs or manipulations received at device 102. The inputs can initiate a process that causes the device 102 to retrieve a user 106 associated with the device 102. In one instance, the user profile may be automatically retrieved in response to the inputs received by the device 102. In other instances, the user profile may be retrieved in response to a login associating the particular user to the device 102. Still in other instances, the user profile may be detected or recognized based on a communication with a secondary device 104 and/or user. For example, a secondary device 104 (e.g., Alexa) communicating with the primary device 102 (e.g., television) about context presented by the user 106 to the secondary device. Note that numerous other methods for retrieving a user profile may be contemplated.

The user profile may include a wide range of information pertaining to the user 106. For example, the user profile may include personal information including but not limited to, age, race, address, date of birth, etc. As another example, the user profile may include financial information including but not limited to, account numbers, financial institution information, payment provider account information, login information, transactional history, etc. The user profile may also include user interest, clothing size, clothing style preferences, hobbies, job description, movie genres, music preferences, search history, psychographics, behavior, temporal context, demographics, etc. In addition, the user profile may also include user biometric information which may be further categorized to include environmental factor associated with the biometric information. Additionally or alternatively, the biometric information and/or other information may be stored separately and/or in separate profiles. For example, a user may also have a body chemistry profile, which stores user body conditions, body chemistry, environmental factors and the like, for the user. As another example, an engagement level profile may exist which includes information regarding tagged past searches, topics of interest, time of day, click propensity (based on current topic), engagement levels, and correlations between them.

Once the user profile has been retrieved, process 300 continues to operation 304 where user biometrics are measured. The measurement of user biometrics can include the user of the multiple sensors available on device 102 to determine the current state of the user 102. For example, a camera may be used to record eye movement. An accelerometer may be used to determine movement on a device (e.g., is user walking, running, etc.) As another example, a microphone can record and using speech recognition techniques determine what user is doing and his/her interest, plans, relationships, etc.

In one embodiment, user biometrics are obtained (or partially obtained) by a secondary device 104. That is to say, a fitness tracker, smart watch, or the like, can monitor and measure the user biometrics (e.g., heart rate, blood pressure, etc.) and communicate the measurements to the device 102. In other embodiments, user biometrics are retrieved from the user profile and/or user body chemistry profile.

In operation 306, the user engagement level is determined. To determine the user engagement level, numerous factors can be considered. For example, the user profile as retrieved from operation 302 is considered. Additionally or alternatively, measured user biometrics 304 and/or body chemistry conditions may be used.

In one embodiment, the measured user biometric data is used to determine a user engagement level. To measure the user engagement level, an engagement score may be determined that characterizes how engaged or focused a user is on the current information on the device 102. To determine the engagement level score, the various user measurements may be given a value (and normalized as necessary) based on the metric. For example, a user's eye movement that is carefully following the screen and concentrated on an article may receive a higher value as compared to a user's eye movement that is constantly moving in numerous directions or multitasking. Similarly, a user who has an low heart rate can be give a higher value as compared to someone with a high heart rate that may be working out and not necessary able to focus on what is on a screen.

As all the user metrics are determined, the values can be summed and compared against a predetermined threshold value at operation 308. The predetermined threshold value can be determined using statistical analysis or other algorithms that can compute an adequate value that corresponds to a user with a high engagement level. Alternatively, the threshold value may be dynamically determined based on the current status of the user and/or previous user engagement level. That is to say, provided the current status of the user (i.e., is he/she in a relaxed state, multi-tasking, etc.) adjust the threshold to indicate an acceptable value that should be surpass.

If, it is determined that the current engagement level of the user 106 is above the threshold then and process 300 continues to operation 310. In operation 310, the user 106 with a high engagement level score may be concentrated in the current content on display on the device 102 and thus a general advertisement may be presented.

Alternatively, if the engagement level score is below the threshold, then process 300 continues to operation 312. In this instance, the user may not be as focused on the content presented on the device 102. If the user is not focused on the content, then tailored information may be presented to the user 106. For example, as previously illustrated in FIG. 2D, a user 106 may have a high interest in hang gliding. In this instance, the user 106 while experiencing a low engagement level may be presented with advertisements, articles, getaways, etc., relevant to hang gliding. As another example, if the user, based on his/her profile is interested in tennis, during a low engagement level may be presented with tennis classes, tickets to matches, and sporting goods.

To determine what information to present, machine learning algorithms may be implemented such that the machine learns from the user biometrics (e.g., user works out a lot), user profile (e.g., user enjoys coffee every morning), etc. to present tailored information. Statistical models, probabilistic analysis, and predictive analysis may also be used to analyze prior user engagement levels, articles, categories, or other relevant material that caused increased engagement levels, as well as recurrence of topics, URL sites, merchant sites, etc. that are often frequented by the user. Note that other learning models and information may be contemplated that may be used for presenting the tailored information to the user.

As the tailored information is presented to the user 106, the system may continue to monitor the user engagement level and determine whether there is a shift in level of engagement. In other words, process 300 continues to operation 314 to determine whether an increase or decrease in the user engagement score has occurred after the tailored information is presented. If the user's interest or engagement level is greater, then in operation 316, other relevant information may be provided. For example, if the user 106 if provided with an article on the current NFL stats and predictions for the Super Bowl and the user's engagement score increases, then other NFL articles, advertisements, and related information (e.g., user's favorite team) may continue to be available for the user 106. The user may click on the information which can then be displayed in the content portion 204 of the device display while other relevant information continues to show on the advertisement portion 206. Therefore, the location of the content and information presented may be adjusted (dynamically or manually) as preferred and/or determined most appropriate by the user.

Alternatively, if not change in engagement level is identified and/or engagement level continues to be low after operation 312, then the system may continue to monitor the user and update the information accordingly in operation 318. Process 300 may continue until device 102 is no longer manipulated, user biometrics change, and/or user designates that he/she is not interested in receiving advertisements, pop-ups, articles, or the like.

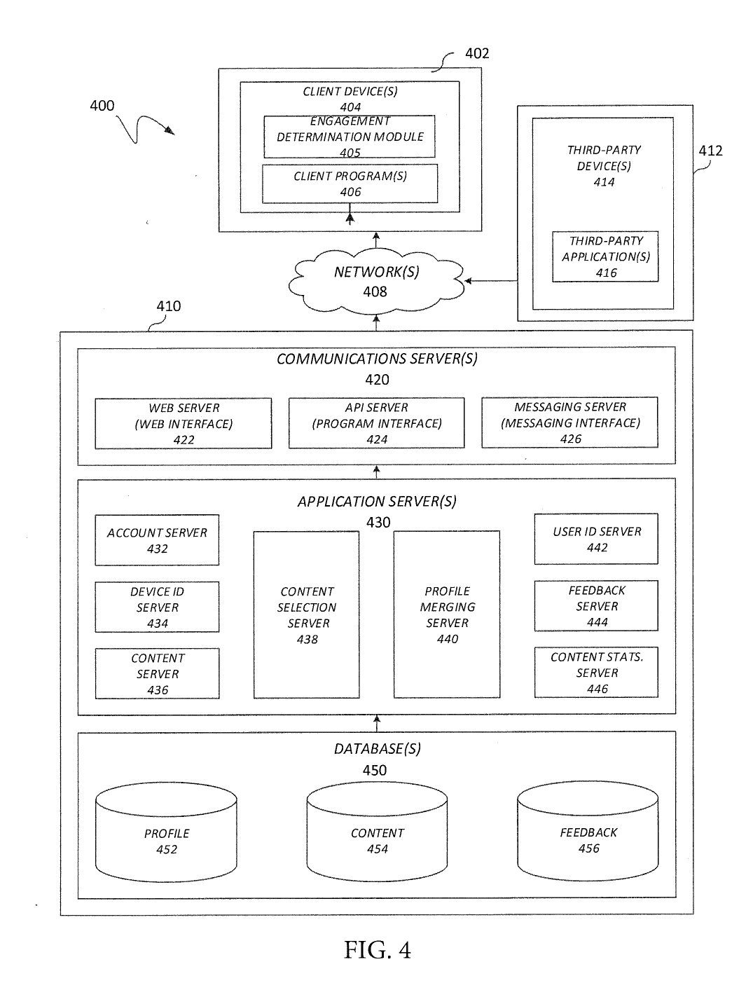

FIG. 4 illustrates, in block diagram format, an example embodiment of a computing environment adapted for implementing a system for queue reduction. As shown, a computing environment 400 may comprise or implement a plurality of servers and/or software components that operate to perform various methodologies in accordance with the described embodiments. Severs may include, for example, stand-alone and enterprise-class servers operating a server operating system (OS) such as a MICROSOFT® OS, a UNIX® OS, a LINUX® OS, or other suitable server-based OS. It may be appreciated that the servers illustrated in FIG. 4 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing environment 400 may include, among various devices, servers, databases and other elements, one or more clients 402 that may comprise or employ one or more client devices 404, such as a laptop, a mobile computing device, a tablet, a PC, a wearable device, and/or any other computing device having computing and/or communications capabilities in accordance with the described embodiments. Client devices 404 may include a cellular telephone, smart phone, electronic wearable device (e.g., smart watch, virtual reality headset), or other similar mobile devices that a user may carry on or about his or her person and access readily.

Client devices 404 generally may provide one or more client programs 406, such as system programs and application programs to perform various computing and/or communications operations. Some example system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Some example application programs may include, without limitation, a web browser application, messaging applications (e.g., e-mail, IM, SMS, MMS, telephone, voicemail, VoIP, video messaging, internet relay chat (IRC)), contacts application, calendar application, electronic document application, database application, media application (e.g., music, video, television), location-based services (LBS) applications (e.g., GPS, mapping, directions, positioning systems, geolocation, point-of-interest, locator) that may utilize hardware components such as an antenna, and so forth. One or more of client programs 406 may display various graphical user interfaces (GUIs) to present information to and/or receive information from one or more users of client devices 404. In some embodiments, client programs 406 may include one or more applications configured to conduct some or all of the functionalities and/or processes discussed below.

Client device 404 (e.g., device 102) may also include an engagement determination module 408, that can be used in network-based system 410 to determine a user's engagement level. The engagement determination module 405 may also be used to retrieve user profile, store and/or retrieve sensor measurements, search history, hobbies, body chemistry profiles and the like for determining the information to be presented to the user. In addition, the engagement determination module may also include the processing and/or work in conjunction with processors such as processor 518 described in FIG. 5 to learn using machine learning algorithms user information to present and for determining and comparing engagement level scores.

As shown, client devices 404 may be communicatively coupled via one or more networks 408 to a network-based system 410. Network-based system 410 may be structured, arranged, and/or configured to allow client 402 to establish one or more communications sessions between network-based system 410 and various computing devices 404 and/or client programs 406. Accordingly, a communications session between client devices 404 and network-based system 410 may involve the unidirectional and/or bidirectional exchange of information and may occur over one or more types of networks 408 depending on the mode of communication. While the embodiment of FIG. 4 illustrates a computing environment 400 deployed in a client-server operating relationship, it is to be understood that other suitable operating environments, relationships, and/or architectures may be used in accordance with the described embodiments.

Data communications between client devices 404 and the network-based system 410 may be sent and received over one or more networks 408 such as the Internet, a WAN, a WWAN, a WLAN, a mobile telephone network, a landline telephone network, personal area network, as well as other suitable networks. For example, client devices 404 may communicate with network-based system 410 over the Internet or other suitable WAN by sending and or receiving information via interaction with a web site, e-mail, IM session, and/or video messaging session. Any of a wide variety of suitable communication types between client devices 404 and system 410 may take place, as will be readily appreciated. In particular, wireless communications of any suitable form may take place between client device 404 and system 410, such as that which often occurs in the case of mobile phones or other personal and/or mobile devices.

In various embodiments, computing environment 400 may include, among other elements, a third party 412, which may comprise or employ third-party devices 414 hosting third-party applications 416. In various implementations, third-party devices 414 and/or third-party applications 416 may host applications associated with or employed by a third party 412. For example, third-party devices 414 and/or third-party applications 416 may enable network-based system 410 to provide client 402 and/or system 410 with additional services and/or information, such as merchant information, data communications, payment services, security functions, customer support, and/or other services, some of which will be discussed in greater detail below. Third-party devices 414 and/or third-party applications 416 may also provide system 410 and/or client 402 with other information and/or services, such as email services and/or information, property transfer and/or handling, purchase services and/or information, and/or other online services and/or information.

In one embodiment, third-party devices 414 may include one or more servers, such as a transaction server that manages and archives transactions. In some embodiments, the third-party devices may include a purchase database that can provide information regarding purchases of different items and/or products. In yet another embodiment, third-party severs 414 may include one or more servers for aggregating consumer data, purchase data, and other statistics.

Network-based system 410 may comprise one or more communications servers 420 to provide suitable interfaces that enable communication using various modes of communication and/or via one or more networks 408. Communications servers 120 may include a web server 422, an API server 424, and/or a messaging server 426 to provide interfaces to one or more application servers 430. Application servers 430 of network-based system 410 may be structured, arranged, and/or configured to provide various online services, merchant identification services, merchant information services, purchasing services, monetary transfers, checkout processing, data gathering, data analysis, and other services to users that access network-based system 410. In various embodiments, client devices 404 and/or third-party devices 414 may communicate with application servers 430 of network-based system 410 via one or more of a web interface provided by web server 422, a programmatic interface provided by API server 424, and/or a messaging interface provided by messaging server 426. It may be appreciated that web server 422, API server 424, and messaging server 426 may be structured, arranged, and/or configured to communicate with various types of client devices 404, third-party devices 414, third-party applications 416, and/or client programs 406 and may interoperate with each other in some implementations.

Web server 422 may be arranged to communicate with web clients and/or applications such as a web browser, web browser toolbar, desktop widget, mobile widget, web-based application, web-based interpreter, virtual machine, mobile applications, and so forth. API server 424 may be arranged to communicate with various client programs 406 and/or a third-party application 416 comprising an implementation of API for network-based system 410. Messaging server 426 may be arranged to communicate with various messaging clients and/or applications such as e-mail, IM, SMS, MMS, telephone, VoIP, video messaging, IRC, and so forth, and messaging server 426 may provide a messaging interface to enable access by client 402 and/or third party 412 to the various services and functions provided by application servers 430.

Application servers 430 of network-based system 410 may be a server that provides various services to clients including, but not limited to, data analysis, geofence management, order processing, checkout processing, and/or the like. Application server 430 of network-based system 410 may provide services to a third party merchants such as real time consumer metric visualizations, real time purchase information, and/or the like. Application servers 430 may include an account server 432, device identification server 434, payment server 436, queue analysis server 438, purchase analysis server 440, geofence server 442, notification server 444, and/or checkout server 446. These servers, which may be in addition to other servers, may be structured and arranged to configure the system for monitoring queues and identifying ways for reducing queue times.

Application servers 430, in turn, may be coupled to and capable of accessing one or more databases 450 including a geofence database 452, an account database 454, transaction database 456, and/or the like. Databases 450 generally may store and maintain various types of information for use by application servers 430 and may comprise or be implemented by various types of computer storage devices (e.g., servers, memory) and/or database structures (e.g., relational, object-oriented, hierarchical, dimensional, network) in accordance with the described embodiments.

FIG. 5 illustrates an example computer system 500 in block diagram format suitable for implementing on one or more devices of the system in FIG. 4. In various implementations, a device that includes computer system 500 may comprise a personal computing device (e.g., a smart or mobile device, a computing tablet, a personal computer, laptop, wearable device, PDA, etc.) that is capable of communicating with a network 526. A service provider and/or a content provider may utilize a network computing device (e.g., a network server) capable of communicating with the network. It should be appreciated that each of the devices utilized by users, service providers, and content providers may be implemented as computer system 600 in a manner as follows.

Additionally, as more and more devices become communication capable, such as new smart devices using wireless communication to report, track, message, relay information and so forth, these devices may be part of computer system 500. For example, windows, walls, and other objects may double as touch screen devices for users to interact with. Such devices may be incorporated with the systems discussed herein.

Computer system 500 may include a bus 510 or other communication mechanisms for communicating information data, signals, and information between various components of computer system 500. Components include an input/output (I/O) component 504 that processes a user action, such as selecting keys from a keypad/keyboard, selecting one or more buttons, links, actuatable elements, etc., and sending a corresponding signal to bus 510. I/O component 504 may also include an output component, such as a display 502 and a cursor control 508 (such as a keyboard, keypad, mouse, touchscreen, etc.). In some examples, I/O component 504 other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 518, which may be a micro-controller, digital signal processor (DSP), or other processing component, that processes these various signals, such as for display on computer system 500 or transmission to other devices over a network 526 via a communication link 524. Again, communication link 524 may be a wireless communication in some embodiments. Processor 518 may also control transmission of information, such as cookies, IP addresses, images, and/or the like to other devices.

Components of computer system 500 also include a system memory component 514 (e.g., RAM), a static storage component 514 (e.g., ROM), and/or a disk drive 516. Computer system 500 performs specific operations by processor 518 and other components by executing one or more sequences of instructions contained in system memory component 512 (e.g., for engagement level determination). Logic may be encoded in a computer readable medium, which may refer to any medium that participates in providing instructions to processor 518 for execution. Such a medium may take many forms, including but not limited to, non-volatile media, volatile media, and/or transmission media. In various implementations, non-volatile media includes optical or magnetic disks, volatile media includes dynamic memory such as system memory component 512, and transmission media includes coaxial cables, copper wire, and fiber optics, including wires that comprise bus 510. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, hard disk, magnetic tape, any other magnetic medium, CD-ROM, any other optical medium, RAM, PROM, EPROM, FLASH-EPROM, any other memory chip or cartridge, or any other medium from which a computer is adapted to read.

Components of computer system 500 may also include a short range communications interface 520. Short range communications interface 520, in various embodiments, may include transceiver circuitry, an antenna, and/or waveguide. Short range communications interface 520 may use one or more short-range wireless communication technologies, protocols, and/or standards (e.g., WiFi, Bluetooth®, Bluetooth Low Energy (BLE), infrared, NFC, etc.).

Short range communications interface 520, in various embodiments, may be configured to detect other devices (e.g., device 102, secondary user device 104, etc.) with short range communications technology near computer system 500. Short range communications interface 520 may create a communication area for detecting other devices with short range communication capabilities. When other devices with short range communications capabilities are placed in the communication area of short range communications interface 520, short range communications interface 520 may detect the other devices and exchange data with the other devices. Short range communications interface 520 may receive identifier data packets from the other devices when in sufficiently close proximity. The identifier data packets may include one or more identifiers, which may be operating system registry entries, cookies associated with an application, identifiers associated with hardware of the other device, and/or various other appropriate identifiers.

In some embodiments, short range communications interface 520 may identify a local area network using a short range communications protocol, such as WiFi, and join the local area network. In some examples, computer system 500 may discover and/or communicate with other devices that are a part of the local area network using short range communications interface 520. In some embodiments, short range communications interface 520 may further exchange data and information with the other devices that are communicatively coupled with short range communications interface 520.

In various embodiments of the present disclosure, execution of instruction sequences to practice the present disclosure may be performed by computer system 500. In various other embodiments of the present disclosure, a plurality of computer systems 500 coupled by communication link 524 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link 624 and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on the user and user device, however, a customer, a merchant, a service or payment provider may otherwise presented with tailored information. Thus, “user” as used herein can also include charities, individuals, and any other entity or person receiving information. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A device comprising:
a non-transitory memory storing instructions; and
a processor configured to execute instructions to cause the system to:
in response to a determination that the device is currently being manipulated, retrieve a user profile associated with the device;
measure, using a plurality of sensors, biometric data for the user of the device;
determine an engagement level score of the user, the engagement level score determined based on the measured biometric data;
determine whether the engagement level score is below a predetermined threshold; and
in response to the determination that the determined engagement level score is below the predetermined threshold, present tailored information to the user based on user profile.

2. The device of claim 1, executing instructions further causes the system to:
in response to the determination that the engagement level score is above the predetermined threshold, present an advertisement.

3. The device of claim 1, executing instructions further causes the system to:
determine whether the engagement level score increases above the predetermined threshold in response to tailored information presented; and
in response to the determination that the engagement level score increased, present an advertisement.

4. The device of claim 1, wherein executing instruction further causes the system to:
determine whether the engagement level score continues below the predetermined threshold in response to tailored information presented; and
in response to the determination, present another tailored information.

5. The device of claim 1, wherein a sensor in the plurality of sensors includes a camera on the device, the camera measuring eye movement of the user.

6. The device of claim 1, wherein a sensor in the plurality of sensors is associated with a second device used by the user.

7. The device of claim 1, wherein a user body chemistry measured by the plurality of sensors is used to determine the engagement level score of the user.

8. The device of claim 7, wherein the measured user body chemistry indicating a user in high activity mode causes the determining of a low engagement level score of the user.

9. The device of claim 1, wherein a sensor in the plurality of sensors measures a blood pressure of the user, wherein a low blood pressure measurement and the engagement level score that is below the predetermined threshold causes the presentation of an article, the article tailored based on the user profile.

10. A method for presenting information using engagement levels, the method comprising:
in response to a determining that the device is currently being manipulated, retrieving a user profile associated with the device;
measuring using a plurality of sensors, biometric data for the user of the device;
determining an engagement level score of the user, the engagement level score determined based on the measured biometric data;
determining whether the engagement level score is below a predetermined threshold; and
in response to the determining that the engagement level score is below the predetermined threshold, present tailored information to the user based on user profile.

11. The method of claim 10, further comprising:
in response to the determining that the engagement level score is above the predetermined threshold, present an advertisement.

12. The method of claim 10, further comprising:
determining whether the engagement level score increases above the predetermined threshold in response to tailored information presented; and
in response to the determining that the engagement level score increased, present an advertisement.

13. The method of claim 10, further comprising:
determining whether the engagement level score continues below the predetermined threshold in response to tailored information presented; and
in response to the determining, present another tailored information.

14. The method of claim 10, wherein a sensor in the plurality of sensors includes a camera on the device, the camera measuring eye movement of the user.

15. The method of claim 10, wherein a sensor in the plurality of sensors is associated with a second device used by the user.

16. The method of claim 10, wherein a user body chemistry measured by the plurality of sensors is used to determine the engagement level score of the user.

17. The method of claim 10, wherein the measured user body chemistry indicating a user in high activity mode causes the determining of a low engagement level score of the user.

18. The method of claim 10, wherein a sensor in the plurality of sensors measures a blood pressure of the user, wherein a low blood pressure measurement and the engagement level score that is below the predetermined threshold causes the presentation of an article, the article tailored based on the user profile.

19. A non-transitory machine readable medium having stored thereon machine readable instructions executable to cause a machine to perform operations comprising:
in response to a determining that the device is currently being manipulated, retrieving a user profile associated with the device;
measuring using a plurality of sensors, biometric data for the user of the device;
determining an engagement level score of the user, the engagement level score determined based on the measured biometric data;
determining whether the engagement level score is below a predetermined threshold; and
in response to the determining that the engagement level score is below the predetermined threshold, present tailored information to the user based on user profile.

20. The non-transitory medium of claim 19, further comprising:
in response to the determining that the engagement level score is above the predetermined threshold, present an advertisement.
